(19) United States
(12) Patent Application Publication
(10) Pub. No.: US 2006/0108464 A1
(43) Pub. Date: May 25, 2006

(54) Vertical mixer with interference knives

(76) Inventor: Gustaaf Maarter Rus, Devon (CA)

Correspondence Address: Gustaaf Rus, 6010 - 47st, Wetaskiwin, AB, T9A 2R3, CA

(21) Appl. No.: 10/994,974

(22) Filed: Nov. 23, 2004

(51) Int. Cl. B02C 19/22

(52) U.S. Cl. 241/260.1; 241/261

(57) ABSTRACT

There is a new and useful invention for the cutting, processing and mixing of material. The invention is comprised of a vertical mixer containing stationary knives interacting with rotating knives. The stationary knives mounted on the tub wall interact with the rotating knives mounted on the radial edge of the rotating auger. This interaction facilitates cutting of large, coarse and dense materials otherwise not readily processed by vertical mixers.

### BACKGROUND OF THE INVENTION

Vertical mixers have been used for agriculture and other industries for many years. These mixers process forage commodities of all types such as hay and silage. They consist of a tub containing one or more vertical augers; these augers have knives mounted on their flighting such that when the augers turn, the knives will cut the forage and the augers will process and mix the commodities within the tub of the mixer.

With the current mixer designs there are commodities that cannot readily be processed. These commodities, such as potatoes, are substantially larger, coarser and denser than standard forage commodities. The inability of vertical mixers to process this type of material quickly and easily has limited their usefulness to some producers. There is a need to improve the vertical mixer's ability to process these commodities.

### SUMMARY OF THE INVENTION

Considered broadly, mixers according to the invention are of the vertical type and comprise a generally circular shaped tub container with one or more augers rotating within the tub. These augers have a plurality of knives mounted on their auger flighting. There is also a plurality of stationary knives mounted on the tub wall. The knives mounted on the tub wall are parallel to the floor of the tub. They are spaced vertically from the floor and extend radially inward toward the rotating axis of the auger. The stationary knives are positioned relative to the knives on the auger such that the stationary knives are vertically offset from the rotating knife on the auger.

The effect of the knives in this arrangement is an aggressive cutting action. The rotating knife forces the commodity between two knives; this causes a scissor cutting action and effectively cuts large and dense commodities.

### BRIEF DESCRIPTION OF THE DRAWINGS

FIG. 1 is a rear view of the invention with a cutout showing the stationary knives and the auger.

FIG. 1A is a detailed view of FIG. 1 showing the cutout.

FIG. 2 is a cutout view showing the relative position of the stationary knives and the auger knife.

FIG. 3 is a top view of the stationary knives.

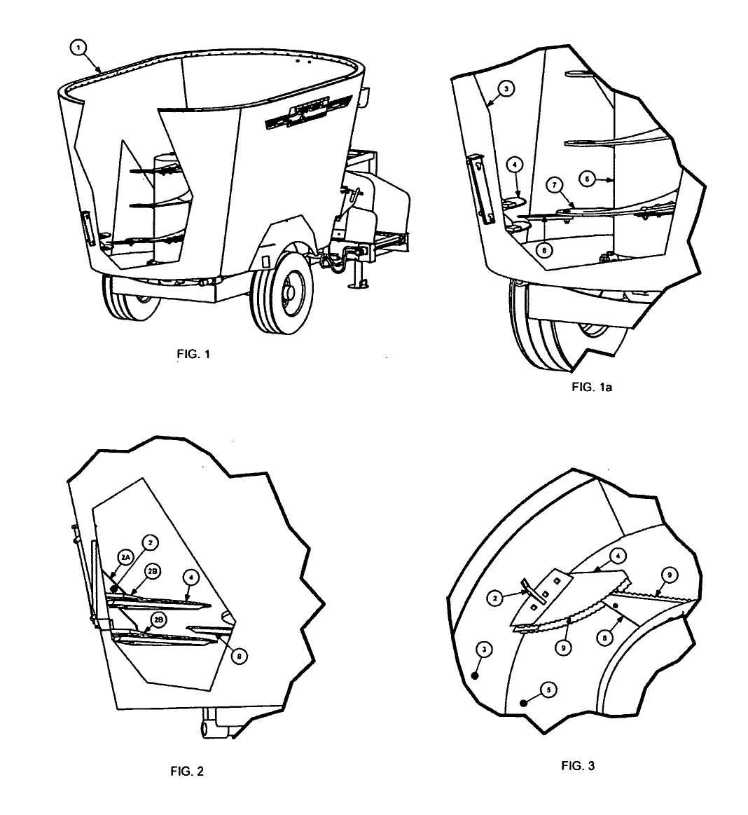

### DETAILED DESCRIPTION OF THE INVENTION

With reference to the drawings, the invention comprises a mixer tub (1) (the mixer tub (1) is described in U.S. Pat. No. 2,152,193). Within the tub, is a stationary knife assembly (2); this assembly is mounted on the tub wall (3). The stationary knife assembly (2) attaches one or more stationary knives (4), to the wall. The stationary knife assembly (2) consists of two or more steel plates (2a & 2b) welded together. The main plate (2a) supports the knife plates (2b); the main plate (2a) is attached to the wall by welding or other means. The knife (4) is bolted to the knife plate (2b). There may be more than one stationary knife assembly (2) within the mixer tub (1). The stationary knife assembly (2) supports the stationary knives (4) parallel to the mixer tub floor (5).

Within the mixer tub is one or more rotating augers (6). Mounted on the radial edge of the auger flighting (7) are knives (8). As the augers are rotated the knife (8) passes between the stationary knives (2) as shown in FIG. 2. This creates scissor action between the stationary knives (2) and moving knife (8). The offset height from the floor (5) at which the stationary knives (4) are mounted is determined by the height of the rotating knives (8). These stationary knives (4) are mounted such that they are above or below a rotating knife's (8) path. FIG. 2 shows the stationary knife assembly (2), the knives (4) are positioned above and below the auger knife (8).

The size of the stationary knife assembly (2) is determined by the size of the auger (7) and the tub (1). The stationary knife (4) must extend out from the tub wall (3) into the path of the auger knife (8). The stationary knife's (4) cutting edge (9) must interfere with the path of the cutting edge of the rotating knife (8). FIG. 3 shows the top view of the interaction between the cutting edges (9) of the stationary (4) and rotating (8) knives.

Although the invention has been described in connection with a preferred embodiment, it should be understood that various modifications, additions and alterations may be made to the invention by one skilled in the art without departing from the spirit and scope of the invention as defined in the appended claims.

The embodiments of the invention in which an exclusive property or privilege is claimed are defined as follows:

1. A mixer tub consisting of:
a. a tub container.
b. an auger or more than one rotating augers have knives mounted on the radial edge of the auger flighting.
c. a stationary knife assembly or knife assemblies supporting one or more knives.

2. The mixer tub recited in claim 1 wherein said stationary knife assembly is fixed to the tub wall.

3. The mixer tub recited in claim 1 wherein said knives mounted on the radial edge of the auger flighting and said knives supported by the stationary knife assembly, interact as the auger turns such that the cutting edges of the knives produce a scissor action as the knives cross paths.

4. The scissor cutting action recited in claim 3 consisting of the cutting edge, of said knife supported by the stationary knife assembly, interacting in near proximity; between 1 to 2 inches of the cutting edge of said knife mounted on the radial edge of the rotating auger.
